(19) United States
(12) Patent Application Publication
(10) Pub. No.: US 2026/0210396 A1
(43) Pub. Date: Jul. 23, 2026

(54) FASTENER, FASTENER SYSTEM, AND METHOD OF FORMING THE FASTENER

(71) Applicant: GM GLOBAL TECHNOLOGY OPERATIONS LLC, Detroit, MI (US)

(72) Inventors: Jianghuai Yang, Rochester Hills, MI (US); Qigui Wang, Rochester Hills, MI (US); Gregory Melekian, Clarkston, MI (US); Wenying Yang, Rochester Hills, MI (US)

(73) Assignee: GM GLOBAL TECHNOLOGY OPERATIONS LLC, Detroit, MI (US)

(21) Appl. No.: 19/028,580

(22) Filed: Jan. 17, 2025

(51) Int. Cl. F16B 33/04; C21D 1/18; C21D 1/34; C21D 9/00; F16B 33/06; F16B 35/04

(52) U.S. Cl. CPC F16B 33/04; C21D 1/18; C21D 1/34; C21D 9/0093; F16B 33/06; F16B 35/048; C21D 2211/001

(57) ABSTRACT

A fastener includes a head disposed at a proximal end of a longitudinal axis and having a first horizontal axis extending therethrough that is perpendicular to the longitudinal axis. The head has a first surface and a bearing surface spaced apart from the first surface across the first horizontal axis. The fastener includes a threaded portion spaced apart from the head along the longitudinal axis and a shank abutting the head at a fillet and disposed between the head and the threaded portion along the longitudinal axis. The fillet has a second horizontal axis extending therethrough that is substantially parallel to the first horizontal axis and intersects the longitudinal axis. The bearing surface and second horizontal axis define a first angle therebetween such that the bearing surface is oblique with respect to the second horizontal axis and longitudinal axis. A fastener system and method of forming the fastener are described.

### INTRODUCTION

The disclosure relates to a fastener, a fastener system, and a method of forming the fastener.

Fasteners, such as bolts and screws, may securely join components and may be used in harsh environments that expose the fasteners to vibration, chemicals, hydrogen, and high tensile forces. One class of fasteners, ultra-high strength fasteners, may be formed from metal and may be useful for applications requiring comparatively high clamp loads, tensile strength, and ductility. Such ultra-high strength fasteners may experience changes in microstructure and mechanical properties under certain conditions.

### SUMMARY

A fastener includes a head disposed at a proximal end of a longitudinal axis and having a first horizontal axis extending therethrough that is perpendicular to the longitudinal axis. The head has a first surface and a bearing surface spaced apart from the first surface across the first horizontal axis. The fastener also includes a threaded portion spaced apart from the head along the longitudinal axis and a shank abutting the head at a fillet and disposed between the head and the threaded portion along the longitudinal axis. The shank includes a first portion that abuts the fillet, has a first diameter, and extends from the head along the longitudinal axis; a second portion extending from the first portion along the longitudinal axis and having a second diameter that is smaller than the first diameter; and a shoulder disposed between the first portion and the second portion. The fillet has a second horizontal axis extending therethrough that is substantially parallel to the first horizontal axis and intersects the longitudinal axis. The bearing surface and the second horizontal axis define a first angle therebetween such that the bearing surface is oblique with respect to the second horizontal axis and the longitudinal axis.

In one aspect, the first diameter may be from 30% greater than to 40% greater than the second diameter such that the shank tapers from the first portion to the second portion at the shoulder.

In an additional aspect, the head may have a head diameter that is greater than the first diameter and the second diameter.

In another aspect, the threaded portion may include a tip spaced apart from the head and disposed at a distal end of the longitudinal axis. The tip may have a thread diameter that is less than the second diameter. The first diameter may be from 110% greater than to 150% greater than the thread diameter.

In a further aspect, the head may include a protrusion extending from the first surface along the longitudinal axis.

In one aspect, the protrusion may define a recession therein along the longitudinal axis.

In an additional aspect, the protrusion may abut the first surface at a round.

In another aspect, the fastener may have a clamp load of from 80 kilonewtons (kN) to 110 kN, a tensile strength of from 1,170 megapascals (MPa) to 1,590 MPa, and a shear strength of from 819 MPa to 1,113 MPa. The head may have a minimum head thickness between the fillet and the round that is greater than or equal to the clamp load divided by a product of pi, the first diameter, and the shear strength.

In a further aspect, the fastener may be resistant to hydrogen embrittlement at the clamp load such that the head is attached to the shank at the clamp load.

In one aspect, the first angle may have a measurement of from 10 degrees to 30 degrees.

In an additional aspect, the fillet may have a fillet radius of from 0.6 millimeters (mm) to 1.5 mm.

In another aspect, the fastener may be formed from a steel alloy having a composition including molybdenum in an amount of greater than 0.3 parts by weight molybdenum based on 100 parts by weight of the steel alloy.

In a further aspect, the fastener may include an organic coating disposed on the head, the shank, and the threaded portion.

A fastener system includes a fastener including a head disposed at a proximal end of a longitudinal axis and having a first horizontal axis extending therethrough that is perpendicular to the longitudinal axis. The head has a first surface and a bearing surface spaced apart from the first surface across the first horizontal axis. The fastener also includes a threaded portion spaced apart from the head along the longitudinal axis and a shank abutting the head at a fillet and disposed between the head and the threaded portion along the longitudinal axis. The shank includes a first portion that abuts the fillet, has a first diameter, and extends from the head along the longitudinal axis; a second portion extending from the first portion along the longitudinal axis and having a second diameter that is smaller than the first diameter; and a shoulder disposed between the first portion and the second portion. The fillet has a second horizontal axis extending therethrough that is substantially parallel to the first horizontal axis and intersects the longitudinal axis. The bearing surface and the second horizontal axis define a first angle therebetween such that the bearing surface is oblique with respect to the second horizontal axis and the longitudinal axis. The fastener system also includes an element defining a bore therein and having a mating surface. The fastener is disposable within the bore such that the bearing surface abuts the mating surface and the head protrudes from the bore along the longitudinal axis.

In one aspect, the mating surface and the second horizontal axis may define a second angle therebetween that is substantially equal to the acute angle such that the mating surface is slanted with respect to the second horizontal axis and the longitudinal axis.

In an additional aspect, a vehicle may include the fastener system.

A method of forming a fastener includes cold heading a blank to produce a workpiece. The workpiece includes a head disposed at a proximal end of a longitudinal axis and having a first horizontal axis extending therethrough that is perpendicular to the longitudinal axis. The head has a first surface and a bearing surface spaced apart from the first surface across the first horizontal axis. The fastener also includes a shank abutting the head at a fillet and extending along the longitudinal axis. The shank includes a first portion that abuts the fillet, has a first diameter, and extends from the head along the longitudinal axis; a second portion extending from the first portion along the longitudinal axis and having a second diameter that is smaller than the first diameter; and a shoulder disposed between the first portion and the second portion. The fillet has a second horizontal axis extending therethrough that is substantially parallel to the first horizontal axis and intersects the longitudinal axis. The bearing surface and the second horizontal axis define a first angle therebetween such that the bearing surface is oblique with respect to the second horizontal axis and the longitudinal axis. After cold heading, the method includes pre-rolling a plurality of threads having an initial thread diameter on the workpiece to form a threaded portion spaced apart from the head along the longitudinal axis such that the shank is disposed between the head and the threaded portion. After pre-rolling, the method includes heat treating the workpiece. After heat treating, the method includes re-rolling the plurality of threads so that the plurality of threads have a thread diameter that is less than the initial thread diameter. After re-rolling, the method includes generating compressive residual stress in the fillet. The method also includes, after generating, coating the workpiece to thereby form the fastener.

In one aspect, re-rolling the plurality of threads may include generating compressive residual stress in the workpiece and trapping absorbed hydrogen in the workpiece to thereby reduce a sensitivity to hydrogen embrittlement.

In an additional aspect, generating compressive residual stress may include at least one of shot peening the fillet and rolling the fillet to trap absorbed hydrogen in the workpiece and thereby reduce a sensitivity to hydrogen embrittlement.

In another aspect, heat treating the workpiece may include austenitizing the workpiece at from 830 degrees Celsius (° C.) to 880° C. for from 0.5 hours to 1 hour; after austenitizing, austempering the workpiece at from 260° C. to 450° C. for from 1.5 hours to 3.5 hours; after austempering, tempering the workpiece at from 250° C. to 400° C.; and after tempering, air cooling the workpiece.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a cross-sectional view of a fastener system including a fastener.

FIG. 2 is a schematic illustration of a plan view of vehicle including the fastener system of FIG. 1.

FIG. 3 is a schematic flow diagram of a method of forming the fastener of FIG. 1.

### DETAILED DESCRIPTION

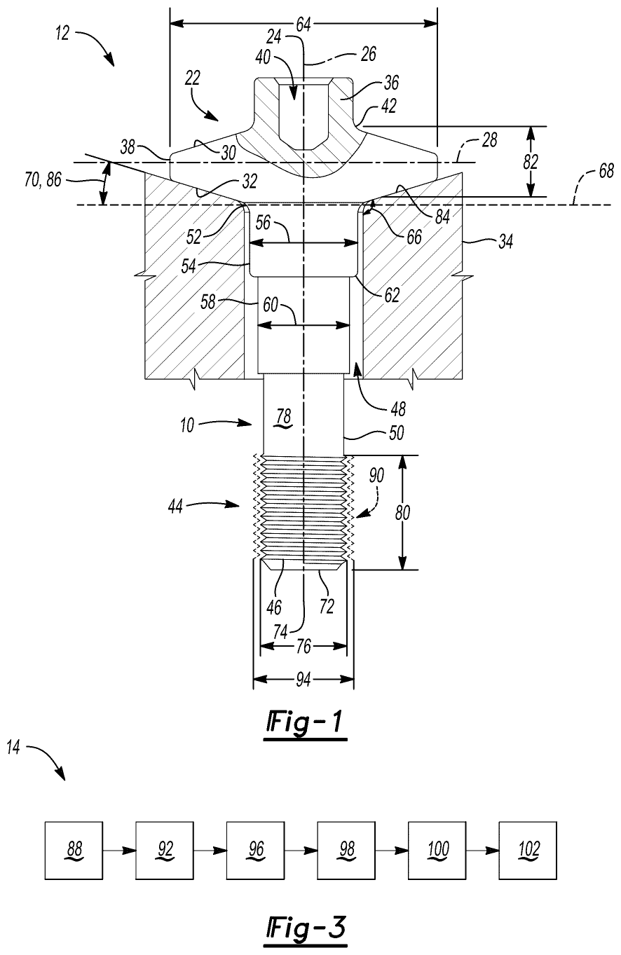

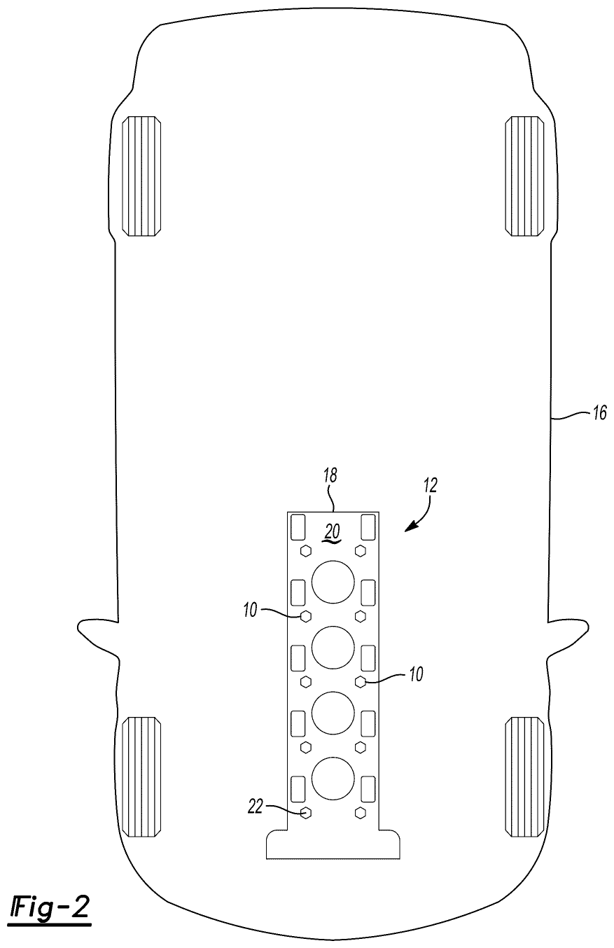

Referring to the Figures, wherein like reference numerals refer to like elements, a fastener 10 (FIG. 1), a fastener system 12 (FIGS. 1 and 2), and a method 14 (FIG. 3) of forming the fastener 10 are shown generally. The fastener 10, fastener system 12, and method 14 may be useful for joining together components with ultra-high strength fasteners 10 that exhibit reduced sensitivity to embrittlement upon exposure to hydrogen. In particular, the fastener 10 and fastener system 12 may be useful for bolting together components with comparatively high clamp loads, e.g., from 80 kilonewtons (kN) to 110 kN, without affecting a microstructure or mechanical properties of the fastener 10. More specifically, and as set forth in more detail below, the fastener 10 and fastener system 12 may have reduced sensitivity to hydrogen embrittlement, improved fatigue resistance, and excellent clamp load consistency. Further, the fastener 10 may be lightweight, may be classified as ultra-high strength under property class 11.9 to property class 15.9, and may be suitable for various applications. The terminology property class refers to a numerical designation set by the International Standards Organization to indicate a strength of a metric fastener 10, based on its tensile strength and yield strength, with higher numbers signifying stronger fasteners 10.

Hydrogen embrittlement is a mechanism that can change the mechanical properties of articles formed from a metal. More specifically, hydrogen embrittlement may occur when hydrogen atoms penetrate a crystal lattice structure of the metal. In particular, hydrogen atoms may penetrate a surface of the metal, diffuse through the metal, accumulate at grain boundaries or other microstructural defects, and create localized stresses in the metal. In some circumstances, such as use of the articles in hydrogen-rich environments, hydrogen embrittlement may cause the metal to exhibit reduced ductility and toughness.

Referring again to FIG. 1, the fastener 10 and fastener system 12 may be useful for automotive applications such as, but not limited to, vehicles 16 (FIG. 2) including internal combustion engine vehicles, electric vehicles, hybrid vehicles, and the like. For example, the vehicle 16 may be a motor vehicle powered by a motive power source including at least one of an internal combustion engine, an electric motor, and an energy storage device, and the vehicle 16 may include the fastener system 12 and the fastener 10. By way of non-limiting examples, the fastener 10 may be a cylinder bolt, chassis bolt, screw, and the like that is capable of fastening together components with comparatively high clamp loads and without compromised integrity. In one non-limiting example best shown in FIG. 2, the fastener 10 may be a cylinder bolt configured for joining together an engine block 18, cylinder head gasket (not shown), and cylinder head 20 for the vehicle 16 without leakage. In other non-liming examples, the fastener 10 may be a bolt or screw configured for joining together chassis or other powertrain components.

Further, the vehicle 16 may be configured for autonomous or automated driving in which the vehicle 16 may be controlled or driven by technology including hardware and software, whether remote to the vehicle 16 or onboard the vehicle 16, that is capable of driving the vehicle 16 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the fastener 10, fastener system 12, and vehicle 16 may be useful for non-automotive applications such as, but not limited to, aerospace, aviation, marine, mass transportation, agricultural, industrial, and rail applications. For example, the vehicle 16 may be, but is not limited to, a commercial vehicle, industrial vehicle, passenger vehicle, automated guided vehicle (AGV), aircraft, watercraft, train, trolley, bus, or the like. It is also contemplated that the vehicle 16 may be a mobile platform, such as an airplane, all-terrain vehicle (ATV), boat, personal movement apparatus, robot, and the like to accomplish the purposes of this disclosure.

Further, the fastener 10, fastener system 12, and method 14 may be useful for applications requiring joining non-vehicular components with the fastener 10. Such applications may include, but are not limited to, consumer goods, medical devices, electronics, structural elements, architectural elements, building components, furniture, metal fabrications, chemical processing, oil and gas production, and hydrogen storage.

### Fastener

Referring now to FIG. 1, the fastener 10 includes a head 22 disposed at a proximal end 24 of a longitudinal axis 26 and having a first horizontal axis 28 extending therethrough that is perpendicular to the longitudinal axis 26. The head 22 may be configured for engaging with a fastening tool (not shown), such as a wrench or driver, to tighten the fastener 10 to comparatively high clamp loads of from 80 kN to 110 kN. Although dependent upon a desired application of the fastener 10, when viewed from above as in FIG. 2, the head 22 may have a hexagonal or square shape.

As described with continued reference to FIG. 1, the head 22 has a first surface 30 and a bearing surface 32 spaced apart from the first surface 30 across the first horizontal axis 28. The first surface 30 may be configured as a top of the head 22 and fastener 10 and the bearing surface 32 may be configured for mating with a component or element 34 to be joined, as set forth in more detail below. Further, the head 22 may also include a torque surface 38 interconnecting the first surface 30 and the bearing surface 32 that is configured for aligning and engaging with the fastening tool (not shown) during tightening of the fastener 10.

As best shown in FIG. 1, the head 22 also includes a protrusion 36 extending from the first surface 30 along the longitudinal axis 26. The protrusion 36 may also be configured for aligning and engaging with the fastening tool (not shown) during tightening of the fastener 10. The protrusion 36 may define a recession 40 therein along the longitudinal axis 26, which may be useful for lightweighting or reducing an overall weight of the fastener 10. Further, the protrusion 36 may abut the first surface 30 at a round 42. That is, the round 42 may provide a gradual transition between the protrusion 36 and the first surface 30 to minimize stress at the transition and reduce sensitivity of the protrusion 36 to shear stress.

Referring again to FIG. 1, the fastener 10 also includes a threaded portion 44 spaced apart from the head 22 along the longitudinal axis 26. The threaded portion 44 may include a plurality of threads 46 together configured for anchoring the fastener 10 within a bore 48 defined by an element 34. For example, the element 34 may be the cylinder head 20 (FIG. 2) formed from cast aluminum. The threaded portion 44 may provide a secure connection between components to be joined by, for example, interlocking with compatible threads (not shown) of the element 34 or shearing into a surface of the element 34. During tightening of the fastener 10, the plurality of threads 46 may rotate to linearly translate the fastener 10 along the longitudinal axis 26 relative to the element 34.

As described with continued reference to FIG. 1, the fastener 10 also includes a shank 50 abutting the head 22 at a fillet 52 and disposed between the head 22 and the threaded portion 44 along the longitudinal axis 26. The shank 50 may be a smooth, threadless or unthreaded portion of the fastener 10 and may be configured to restrict lateral movement of the fastener 10 and joined components to ensure that the fastener system 12 maintains stability under load and vibration. Further, the shank 50 may provide the fastener 10 with excellent shear resistance and elastic resilience.

In particular, referring again to FIG. 1, the shank 50 includes a first portion 54 that abuts the fillet 52, has a first diameter 56, and extends from the head 22 along the longitudinal axis 26. Further, the shank 50 has a second portion 58 extending from the first portion 54 along the longitudinal axis 26 and having a second diameter 60 that is smaller than the first diameter 56. The shank 50 also has a shoulder 62 disposed between the first portion 54 and the second portion 58.

The first diameter 56 may be from 30% greater than to 40% greater than, e.g., from 32% greater than to 35% greater than, the second diameter 60 such that the shank 50 tapers from the first portion 54 to the second portion 58 at the shoulder. Such an increased first diameter 56 as compared to the second diameter 60 may reduce a stress concentration at the fillet 52 and thereby reduce a sensitivity of the fastener 10 to hydrogen embrittlement. Further, the head 22 may have a head diameter 64 that is greater than the first diameter 56 and the second diameter 60. That is, the head 22 may be wider than the first portion 54 and the second portion 58 of the shank 50.

As described with continued reference to FIG. 1, the fillet 52 may be configured to reduce stress at an intersection or transition between the shank 50 and the bearing surface 32. More specifically, the fillet 52 may be rounded and may have a fillet radius 66 of from 0.6 millimeters (mm) to 1.5 mm, e.g., from 0.8 mm to 1.3 mm or from 1 mm to 1.2 mm or about 1.1 mm. As such, the fillet 52 may reduce a stress concentration at the intersection of the shank 50 and the bearing surface 32. Further, a combination of the fillet radius 66 and the first diameter 56 may contribute to a reduced susceptibility or sensitivity of the fastener 10 to hydrogen embrittlement. That is, at fillet radii 66 of less than 0.6 mm or greater than 1.5 mm, the fastener 10 may exhibit increased stress concentrations at the intersection of the shank 50 and the bearing surface 32 and may experience increased sensitivity to hydrogen embrittlement.

In addition, the fillet 52 has a second horizontal axis 68 extending therethrough that is substantially parallel to the first horizontal axis 28 and intersects the longitudinal axis 26. Further, the bearing surface 32 and the second horizontal axis 68 define a first angle 70 therebetween such that the bearing surface 32 is oblique with respect to the second horizontal axis 68 and the longitudinal axis 26. In particular, the first angle 70 may be acute and may have a measurement of from 10 degrees to 30 degrees, e.g., from 15 degrees to 25 degrees or about 20 degrees. The first angle 70 may also contribute to the excellent resistance to hydrogen embrittlement of the fastener 10. Stated differently, at first angle 70 measurements that are less than 10 degrees or greater than 30 degrees, the fastener 10 may likewise exhibit increased stress concentrations at the intersection of the shank 50 and the bearing surface 32, i.e., at the fillet 52, and may experience increased sensitivity to hydrogen embrittlement.

Referring again to FIG. 1, the threaded portion 44 may further include a tip 72 spaced apart from the head 22 and disposed at a distal end 74 of the longitudinal axis 26. The tip 72 may have a thread diameter 76 that is less than the second diameter 60. That is, the tip 72 of the threaded portion 44 may taper from the shank 50 at the distal end 74 of the longitudinal axis 26. As such, the tip 72 may lead the fastener 10 as the fastener 10 translates into the bore 48 along the longitudinal axis 26 during tightening.

As shown in FIG. 1, the first diameter 56 may be from 110% greater than to 150% greater than the thread diameter 76, e.g., from 120% greater than to 140% greater than or about 130% greater than the thread diameter 76. Such an increased first diameter 56 as compared to the thread diameter 76 may provide the fastener 10 with reduced stress at the fillet 52 and a reduced susceptibility of the fastener 10 to hydrogen embrittlement. For examples in which the first diameter 56 is 130% greater than the thread diameter 76, stress at the fillet 52 may be reduced by 23.5% as compared to a comparative fastening device (not shown) having a first diameter 56 that is equal to the thread diameter 76. Further, at first diameters 56 that are less than 110% or greater than 150% larger than the thread diameter 76, the fastener 10 may likewise exhibit increased stress concentrations at the intersection of the shank 50 and the bearing surface 32 and may experience increased sensitivity to hydrogen embrittlement.

Further, in some non-limiting examples, the fastener 10 may include an organic coating 78 (FIG. 1) disposed on the head 22, the shank 50, and the threaded portion 44. The organic coating 78 may protect the fastener 10 from hydrogen introduction into the microstructure of the metal by providing a physical barrier to hydrogen molecules. The organic coating 78 may also provide the fastener 10 with an excellent coefficient of friction of from 0.1 to 0.15 and clamp load consistency during tightening of the fastener 10.

The fastener 10 may be formed from a steel alloy having a composition including molybdenum in an amount of greater than 0.3 parts by weight based on 100 parts by weight of the steel alloy. Further, the steel alloy may have a medium to high carbon content. For example, the steel alloy may be selected from, but is not limited to, 4340 steel, 4140 steel, 42CrMo steel, tool steel, spring steel, and the like. In contrast, other types of non-premium steel alloys may result in an increased susceptibility to hydrogen embrittlement when the fastener 10 is used in hydrogen-rich environments.

The fastener 10 may have a clamp load of from 80 kN to 110 kN, wherein 1 kN is equal to 1,000 newtons (N), a tensile strength of from 1,170 megapascals (MPa) to 1,590 MPa, wherein 1 MPa is equal to 1×10⁶ pascals (Pa), and a shear strength along a thread height 80 (FIG. 1) of from 819 MPa to 1,113 MPa. For example, the fastener 10 may have a clamp load of from 90 kN to 100 kN or about 95 kN and may be classified as an ultra-high strength fastener 10. In some examples, the fastener 10 may have a tensile strength of from 1,250 MPa to 1,450 MPa or from 1,300 MPa to 1,400 MPa or about 1,350 MPa. In some examples, the fastener 10 may have a shear strength of from 900 MPa to 1,000 MPa or about 950 MPa, depending upon a number of the plurality of threads 46 (FIG. 1) and the thread height 80 (FIG. 1).

Further, referring again to FIG. 1, the head 22 may have a minimum head thickness 82 between the fillet 52 and the round 42 that is greater than or equal to the clamp load divided by a product of pi, the first diameter 56, and the shear strength. As such, the fastener 10 may be resistant to hydrogen embrittlement at the comparatively high clamp load such that the head 22 is attached to the shank 50 at the clamp load. That is, the fastener 10 may specifically be resistant to hydrogen embrittlement at the fillet 52 such that the head 22 may not separate from the shank 50 during operation of the fastener 10. However, at head thicknesses 82 of less than the clamp load divided by a product of pi, the first diameter 56, and the shear strength, the fastener 10 may exhibit increased stress concentrations at the intersection of the shank 50 and the bearing surface 32 and may experience increased sensitivity to hydrogen embrittlement.

### Fastener System

Referring now to FIG. 2, the fastener system 12 includes the fastener 10 and the element 34 defining the bore 48 therein. As best shown in FIG. 1, the element 34 has a mating surface 84 that is configured to align and contact the bearing surface 32 of the fastener 10. As such, the mating surface 84 and the bearing surface 32 may be similarly shaped. In particular, the fastener 10 is disposable within the bore 48 such that the bearing surface 32 abuts the mating surface 84 and the head 22 protrudes from the bore 48 along the longitudinal axis 26.

More specifically, as best described with reference to FIG. 1, the mating surface 84 and the second horizontal axis 68 may define a second angle 86 therebetween that is substantially equal to the first angle 70 such that the second angle 86 is slanted with respect to the second horizontal axis 68 and the longitudinal axis 26. As such, the mating surface 84 and the bearing surface 32 may be similarly slanted with respect to the second horizontal axis 68 and may precisely contact one another as the fastener 10 is tightened to the clamp load. Such slanted or oblique mating and bearing surfaces 84, 32 may be particularly advantageous for applications in which the fastener 10 is a cylinder bolt that joins together a cast aluminum cylinder head 20 (FIG. 2) and engine block 18 (FIG. 2). That is, the slanted mating surface 84 and oblique bearing surface 32 may reduce stress and creep in the aluminum and avoid clamp load relaxation and joint leakage.

### Method of Forming the Fastener

Referring now to FIG. 3, the method 14 of forming the fastener 10 includes cold heading 88 a blank to produce a workpiece 90 (FIG. 1). The blank may be formed from metal, such as the aforementioned steel alloys, may have a microstructure that includes bainite and minimum tempered martensite, i.e., steel that has undergone a minimal amount of heat treatment at the lowest possible temperature needed to temper martensite to achieve a desired balance between hardness and toughness while alleviating excessive brittleness, may have a hardness of from 38 HRC to 50 HRC on the Hardness Rockwell C scale, and may be shaped through cold heading 88 to form the workpiece 90. That is, cold heading 88 may include metal forming the blank, for example with high-speed tooling, to shape the blank into the workpiece 90 without heat. Cold heading 88 may improve a grain structure of the metal and may strengthen the fastener 10.

As described with reference to FIG. 1, the workpiece 90 may be a precursor to the fastener 10 and includes the head 22 disposed at the proximal end 24 of the longitudinal axis 26 and having the first horizontal axis 28 extending therethrough that is perpendicular to the longitudinal axis 26. As set forth above, the head 22 has the first surface 30 and the bearing surface 32 spaced apart from the first surface 30 across the first horizontal axis 28.

The workpiece 90 further includes the shank 50 abutting the head 22 at the fillet 52 and extending along the longitudinal axis 26. The shank 50 includes the first portion 54 that abuts the fillet 52, has a first diameter 56, and extends from the head 22 along the longitudinal axis 26. Further, the shank 50 has a second portion 58 extending from the first portion 54 along the longitudinal axis 26 and having a second diameter 60 that is smaller than the first diameter 56. The shank 50 also has a shoulder 62 disposed between the first portion 54 and the second portion 58.

The fillet 52 of the workpiece 90 has the second horizontal axis 68 extending therethrough that is substantially parallel to the first horizontal axis 28 and intersects the longitudinal axis 26. The bearing surface 32 and the second horizontal axis 68 define the first angle 70 therebetween such that the bearing surface 32 is oblique with respect to the second horizontal axis 68 and the longitudinal axis 26.

Referring again to FIG. 3, the method 14 also includes, after cold heading 88, pre-rolling 92 the plurality of threads 46 having an initial thread diameter 94 (FIG. 1) on the workpiece 90 to form the threaded portion 44 spaced apart from the head 22 along the longitudinal axis 26 such that the shank 50 is disposed between the head 22 and the threaded portion 44. Pre-rolling 92 may be a first process for developing the plurality of threads 46 of the fastener 10. In particular, pre-rolling 92 may include providing fine or coarse threads 46 having the initial thread diameter 94 that is larger than the finished thread diameter 76.

After pre-rolling 92, the method 14 includes heat treating 96 the workpiece 90. Stated differently, pre-rolling 92 occurs before heat treating 96 the workpiece 90. In one non-limiting example, heat treating 96 the workpiece 90 may include austenitizing the workpiece at from 830 degrees Celsius (° C.) to 880° C. for from 0.5 hours to 1 hour, e.g., at about 850° C. for about 45 minutes, to transform the crystalline microstructure of the metal into austenite; after austenitizing, austempering the workpiece 90 at from 260° C. to 450° C. for from 1.5 hours to 3.5 hours, e.g., at about 325° C. for about 2.5 hours, to improve mechanical properties of the metal; after austempering, tempering the workpiece 90 at from 250° C. to 400° C., e.g., at about 325° C., to reduce a brittleness and increase a flexibility of the metal; and after tempering, air cooling the workpiece 90, as opposed to quenching the workpiece 90, to allow for a controlled, gradual cooling of the metal. In contrast to quenching the workpiece 90, such controlled, gradual cooling of the metal may reduce internal stress within the metal while maintaining a level of hardness achieved during tempering.

Referring to FIG. 3, after heat treating 96, the method 14 includes re-rolling 98 the plurality of threads 46 so that the plurality of threads 46 have the finished thread diameter 76 (FIG. 1) that is less than the initial thread diameter 94 (FIG. 1). That is, the method 14 includes a two-step forming of the plurality of threads 46, i.e., pre-rolling 92 before heat treating 96 and re-rolling 98 after heat treating 96, to finalize the smaller thread diameter 76 as compared to the rough, initial thread diameter 94. Such re-rolling 98 after pre-rolling 92 may also reduce roller die wear and may trap hydrogen absorbed during processing. That is, re-rolling 98 the plurality of threads 46 may include generating compressive residual stress in the workpiece 90 and trapping absorbed hydrogen in the workpiece 90 to thereby reduce a sensitivity to hydrogen embrittlement while also providing excellent fatigue resistance. For example, re-rolling 98 may generate a compressive residual stress of greater than −500 MPa.

After re-rolling 98, the method 14 includes generating 100 compressive residual stress in the fillet 52. Generating 100 may include at least one of shot peening the fillet 52 and rolling the fillet 52 to trap absorbed hydrogen in the workpiece 90 and thereby reduce a sensitivity to hydrogen embrittlement. The at least one of shot peening and rolling the fillet 52 may also provide the fastener 10 with excellent fatigue strength.

More specifically, shot peening the fillet 52 may include shooting cast steel shot or stainless steel shot having a size of from 0.2 mm to 0.5 mm from a nozzle at the fillet 52 at a coverage of from 100% of the fillet 52 to 120% of the fillet 52 such that 100% to 120% of a surface of the fillet 52 is impacted by the cast steel shot or stainless steel shot at a depth of from 0.15 mm to 0.25 mm. As the shot impacts the fillet 52, the shot may induce the compressive residual stress of from −1,200 MPa to −500 MPa at a depth of 0.05 mm. As such, shot peening may form an armor to trap or lock hydrogen in the workpiece 90.

Rolling the fillet 52 may occur after heat treating 96 the fillet 52 and may include compressing the plurality of threads 46 with a selected rolling die at a selected rolling force. Such rolling may similarly induce the compressive residual stress of from −1,200 MPa to −500 MPa at a depth of 0.05 mm.

As shown in FIG. 3, after generating 100, the method 14 includes coating 102 the workpiece 90 to thereby form the fastener 10. For example, coating 102 may include disposing the organic coating 78 on the head 22, the shank 50, and the threaded portion 44 to thereby form the fastener 10. As such, coating 102 may include protecting the fastener 10 from hydrogen introduction into the microstructure of the metal.

Therefore, in summary, the fastener 10, fastener system 12, and method 14 may be suitable for applications requiring ultra-high strength bolts or screws having excellent resistance to hydrogen embrittlement. In particular, a combination of the aforementioned oblique bearing surface 32 and slanted mating surface 84; comparatively large first diameter 56 of the shank 50 as compared to the thread diameter 76; fillet radius 66; and recession 40 defined by the protrusion 36 of the head 22; along with formation from premium steel alloys, and the unique method 14 of forming that includes pre-rolling 92, heat treating 96, re-rolling 98, and at least one of shot peening and rolling the fillet 52, provides the fastener 10 with excellent strength and fatigue resistance and reduced susceptibility to hydrogen embrittlement in hydrogen-rich environments.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A fastener comprising:
a head disposed at a proximal end of a longitudinal axis and having a first horizontal axis extending therethrough that is perpendicular to the longitudinal axis;
wherein the head has a first surface and a bearing surface spaced apart from the first surface across the first horizontal axis;
a threaded portion spaced apart from the head along the longitudinal axis; and
a shank abutting the head at a fillet and disposed between the head and the threaded portion along the longitudinal axis;
wherein the shank includes:
a first portion that abuts the fillet, has a first diameter, and extends from the head along the longitudinal axis;
a second portion extending from the first portion along the longitudinal axis and having a second diameter that is smaller than the first diameter; and
a shoulder disposed between the first portion and the second portion;
wherein the fillet has a second horizontal axis extending therethrough that is substantially parallel to the first horizontal axis and intersects the longitudinal axis; and
wherein the bearing surface and the second horizontal axis define a first angle therebetween such that the bearing surface is oblique with respect to the second horizontal axis and the longitudinal axis.

2. The fastener of claim 1, wherein the first diameter is from 30% greater than to 40% greater than the second diameter such that the shank tapers from the first portion to the second portion at the shoulder.

3. The fastener of claim 1, wherein the head has a head diameter that is greater than the first diameter and the second diameter.

4. The fastener of claim 1, wherein the threaded portion includes a tip spaced apart from the head and disposed at a distal end of the longitudinal axis;
wherein the tip has a thread diameter that is less than the second diameter; and
wherein the first diameter is from 110% greater than to 150% greater than the thread diameter.

5. The fastener of claim 1, wherein the head includes a protrusion extending from the first surface along the longitudinal axis.

6. The fastener of claim 5, wherein the protrusion defines a recession therein along the longitudinal axis.

7. The fastener of claim 5, wherein the protrusion abuts the first surface at a round.

8. The fastener of claim 7, wherein the fastener has a clamp load of from 80 kilonewtons (kN) to 110 kN, a tensile strength of from 1,170 megapascals (MPa) to 1,590 MPa, and a shear strength of from 819 MPa to 1,113 MPa; and
wherein the head has a minimum head thickness between the fillet and the round that is greater than or equal to the clamp load divided by a product of pi, the first diameter, and the shear strength.

9. The fastener of claim 8, wherein the fastener is resistant to hydrogen embrittlement at the clamp load such that the head is attached to the shank at the clamp load.

10. The fastener of claim 1, wherein the first angle has a measurement of from 10 degrees to 30 degrees.

11. The fastener of claim 1, wherein the fillet has a fillet radius of from 0.6 millimeters (mm) to 1.5 mm.

12. The fastener of claim 1, wherein the fastener is formed from a steel alloy having a composition including molybdenum in an amount of greater than 0.3 parts by weight molybdenum based on 100 parts by weight of the steel alloy.

13. The fastener of claim 1, further including an organic coating disposed on the head, the shank, and the threaded portion.

14. A fastener system comprising:
a fastener including:
a head disposed at a proximal end of a longitudinal axis and having a first horizontal axis extending therethrough that is perpendicular to the longitudinal axis;
wherein the head has a first surface and a bearing surface spaced apart from the first surface across the first horizontal axis;
a threaded portion spaced apart from the head along the longitudinal axis; and
a shank abutting the head at a fillet and disposed between the head and the threaded portion along the longitudinal axis;
wherein the shank includes:
a first portion that abuts the fillet, has a first diameter, and extends from the head along the longitudinal axis;
a second portion extending from the first portion along the longitudinal axis and having a second diameter that is smaller than the first diameter; and
a shoulder disposed between the first portion and the second portion;
wherein the fillet has a second horizontal axis extending therethrough that is substantially parallel to the first horizontal axis and intersects the longitudinal axis; and
wherein the bearing surface and the second horizontal axis define a first angle therebetween such that the bearing surface is oblique with respect to the second horizontal axis and the longitudinal axis; and
an element defining a bore therein and having a mating surface;
wherein the fastener is disposable within the bore such that the bearing surface abuts the mating surface and the head protrudes from the bore along the longitudinal axis.

15. The fastener system of claim 14, wherein the mating surface and the second horizontal axis define a second angle therebetween that is substantially equal to the first angle such that the mating surface is slanted with respect to the second horizontal axis and the longitudinal axis.

16. A vehicle including the fastener system of claim 14.

17. A method of forming a fastener, the method comprising:
cold heading a blank to produce a workpiece;
wherein the workpiece includes:
a head disposed at a proximal end of a longitudinal axis and having a first horizontal axis extending therethrough that is perpendicular to the longitudinal axis;
wherein the head has a first surface and a bearing surface spaced apart from the first surface across the first horizontal axis; and
a shank abutting the head at a fillet and extending along the longitudinal axis;
wherein the shank includes:
a first portion that abuts the fillet, has a first diameter, and extends from the head along the longitudinal axis;
a second portion extending from the first portion along the longitudinal axis and having a second diameter that is smaller than the first diameter; and
a shoulder disposed between the first portion and the second portion;
wherein the fillet has a second horizontal axis extending therethrough that is substantially parallel to the first horizontal axis and intersects the longitudinal axis; and
wherein the bearing surface and the second horizontal axis define a first angle therebetween such that the bearing surface is oblique with respect to the second horizontal axis and the longitudinal axis;
after cold heading, pre-rolling a plurality of threads having an initial thread diameter on the workpiece to form a threaded portion spaced apart from the head along the longitudinal axis such that the shank is disposed between the head and the threaded portion;
after pre-rolling, heat treating the workpiece;
after heat treating, re-rolling the plurality of threads so that the plurality of threads have a thread diameter that is less than the initial thread diameter;
after re-rolling, generating compressive residual stress in the fillet; and
after generating, coating the workpiece to thereby form the fastener.

18. The method of claim 17, wherein re-rolling the plurality of threads includes generating compressive residual stress in the workpiece and trapping absorbed hydrogen in the workpiece to thereby reduce a sensitivity to hydrogen embrittlement.

19. The method of claim 17, wherein generating compressive residual stress includes at least one of shot peening the fillet and rolling the fillet to trap absorbed hydrogen in the workpiece and thereby reduce a sensitivity to hydrogen embrittlement.

20. The method of claim 17, wherein heat treating the workpiece includes:
austenitizing the workpiece at from 830 degrees Celsius (° C.) to 880° C. for from 0.5 hours to 1 hour;
after austenitizing, austempering the workpiece at from 260° C. to 450° C. for from 1.5 hours to 3.5 hours;
after austempering, tempering the workpiece at from 250° C. to 400° C.; and
after tempering, air cooling the workpiece.
